(19) United States
(12) Patent Application Publication
(10) Pub. No.: US 2003/0033996 A1
(43) Pub. Date: Feb. 20, 2003

(54) Internal combustion engine cylinder head

(76) Inventor: William Delaplaine Green, Harrisonburg, VA (US)

Correspondence Address: William DelaPLAINE GREEN, 8906 Camden Street, Alexandria, VA, 22308, US

(21) Appl. No.: 10/212,174

(22) Filed: Aug. 6, 2002

Related U.S. Application Data
(63) Continuation-in-part of application No. 09/922,685, filed on Aug. 7, 2001, now abandoned.

(51) Int. Cl. F02B 33/00

(52) U.S. Cl. 123/68; 123/193.5

(57) ABSTRACT

An internal combustion cylinder head is comprised of a housing formed from three sections horizontally divided along the axis of two parallel horizontal gear shafts and a horizontal parallel camshaft located above them. The valve stems pass between the gear shafts and the valve faces are located below the gear shafts. Meshing the gear shafts together and driving them from the crankshaft form the gear compressor. Internal combustion passages are formed in the housing between the air compressor and an exhaust valve. The compressor is divided into four pumps, two outer oil pumps and two middle air pumps that pump air into the combustion passages. Two internal air intake passages surround the housing enclosing the air compressor and serve to cool the cylinder head as air is drawn through them into the air compressor. When the engine is started the fuel and air pumped into the cylinder head is compressed and ignited in the combustion passages located in the cylinder head between the compressor and central exhaust valve. Compressing and igniting the fuel charge in passages in the cylinder head instead of in the cylinder allows the engine to achieve two-cycle operation. Continually forcing air into these passages increases power.

This is a utility application based upon provisional patent application No. 60/309,481 filed Aug. 3, 2001 and another provisional patent application filed Aug. 3, 2002.

### DISCLOSUE INFORMATION STATEMENT

In preparation for filing this application, a pre-examination patent ability search was performed. Among the classes and subclasses reviewed were Class 123, subclasses 27R, 65B, 65BA, 68, 198C, 213, 257, 268, 316, 528, 533, 559.1, 561, 565, and 564. Computer searching was also done on the PTO patent database.

The search uncovered the following:

| Pat. No. | Inventor | Date of Issue |
|---|---|---|
| 6,135,070 | R. A. Crandall | Oct. 24, 2000 |
| 5,878,703 | K. Sweeney | Mar. 9, 1999 |
| 5,746,163 | E. Green | May 5, 1998 |
| 5,388,561 | H. Cullum, J. Korn | Feb. 14, 1995 |
| 5,375,581 | G. Alander, H Hofmann | Dec. 27, 1994 |
| 5,179,921 | V. Figliuzzi | Jan. 19, 1993 |
| 4,984,540 | K. Morikawa | Jan. 15, 1991 |
| 4,860,699 | J. Rocklein | Aug. 29, 1989 |
| 4,671,218 | C. Weiland | Jun. 9, 1987 |
| 4,539,948 | R. R. Toepel | Sep. 10, 1985 |
| 4,398,509 | B. Offenstadt | Aug. 16, 1983 |
| 2,851,021 | G. W. Covone | Sep. 9, 1958 |
| 2,708,919 | R. D. Wellington | May 24, 1955 |
| 2,686,503 | V. C. Reddy | Aug. 17, 1954 |
| 2,356,379 | D. F. Caris | Aug. 22, 1944 |
| 2,312,661 | D. Messner | Mar. 2, 1943 |
| 2,067,984 | J. Ross | Jan. 19, 1937 |
| 2,062,621 | F. A. Truesdale | Dec. 1, 1936 |
| 1,720,414 | F. Gruebler | Jul. 9, 1929 |
| 1,273,667 | J. A. Poyet | Jul. 23, 1918 |
| 1,220,893 | E. A. Rundlof | Mar. 27, 1917 |

### BACKGROUND OF THE INVENTION

Designs for two stroke internal combustion engines are disclosed in the art that use positive displacement pumps to charge the cylinder with air prior to ignition. Various methods of charging the cylinder with compressed air produced by a positive displacement pump are disclosed in the art. Often a camshaft operated poppet valve closing off the cylinder from the air passage leading from the air compressor to the cylinder is timed by the camshaft to open and allow air from the compressor to enter the cylinder after the power stroke of the engine. By opening this valve early compressed air from the compressor can also be used to scavenge the cylinder of exhaust gases.

One such design is disclosed in U.S. Pat. No. 4,671,218 issued to Weiland. In this patent there is disclosed a gear type positive displacement pump used to charge a holding chamber located above the cylinder with compressed air through which a valve stem projects to the valve face that seals the intake port located in the floor of the holding chamber from the cylinder beneath it. A crankshaft driven camshaft actuates the intake valve while the exhaust ports are open, which are located in the cylinder wall just above the face of the piston when the piston is located at bottom dead center, allowing compressed air from the compressor to fill the cylinder and scavenge the cylinder of remaining exhaust gases.

The blower types described and illustrated in the patents found during a patent search are usually of the Roots type as disclosed in the Toepel Pat. No. 4,539,948 and others, the turbocharger designs as disclosed in the Sweeney Pat. No. 5,878,703 and others, or of the radial type as disclosed in the Rocklein Pat. No. 4,860,699 and others. Only in the Weiland Patent and the Figliuzzi Pat. No. 5, 179,921 do we see a-positive displacement gear pump used as a means to force air into the engine. Although the Weiland design shows a holding chamber located above the intake valve into which compressed air collects prior to the intake valve opening there is nothing shown that indicates any intention to ignite the fuel held within this chamber or an understanding of the beneficial effects upon the engines performance by using the passage above the intake valve as the place to initiate combustion.

In the present described and illustrated invention power production and efficiency advantages are achieved by using a positive displacement gear pump to compress the fuel mixture into the passages located between the compressor and the intake valve sealing the cylinder from these passages and initiating combustion in the passages instead of compressing the fuel mixture in the cylinder between the intake valve and the piston and initiating combustion at the top of the cylinder below the intake valve as is done in all other designs searched.

The reasons for initiating combustion above the intake valve in a compressor charged internal combustion reciprocating piston engine instead of below the intake valve are several. Unlike other designs this design uses a combustion zone open to incoming air during combustion. By initiating combustion above the intake valve the combustion process occurring within these passages is constantly exposed to the air discharge coming from the compressor. This causes a greatly improved turbulence of the fuel mixture inside of the passages improving the flame propagation and burning process effectiveness and speeding it up. Since additional air is constantly being feed into these passages located above the intake valve additional fuel as well as air can be added to the combustion process after it has been initiated greatly increasing the power generation during each power cycle of the engine.

Additionally since the positive displacement gear pump is forcing air into the passages and compressing it there the piston is not involved in the intake and compression cycles of the engine. This leaves the piston responsible for only the power and exhaust cycles of the engine allowing the engine to effectively function as a two cycle engine without many of the inherent problems associated with other two cycle engine designs.

Other two cycle engines normally pass the fuel mixture through the crankcase, which requires a dry sump and oil mixed with the fuel to provide lubrication to the crankshaft causing lubrication problems in the crankcase and reduces the life of the crankshaft bearings. Two cycle engines of this design suffer from the additional problem of the intake charge and the exhaust charge mixing during the exhaust and intake cycles of the engine reducing the power and efficiency of the engine and increases the emissions produced by the engine.

In both two and four cycle engines the opening and closing of the intake port produces volumetric efficiency problems and resultant torque production fluxuations as the rpm of the engine changes due to tuning problems caused by the effect of the wave motions of the intake charge due to the intake charge being forced to move forwards and backwards as the intake valve opens and closes. In conventional two and four-cycle engines no additional fuel or air is introduced into the cylinder until the power cycle is completed because the intake valve remains closed during the power cycle preventing the addition of air and fuel into the combustion process completely eliminating the additional power and efficiency additional air and fuel will help produce if added to the combustion process. Four-cycle engines require two revolutions of the crankshaft for every power cycle thereby producing twice as much friction per power cycle as a two-cycle engine.

All of these defects or deficiencies of conventional two and four cycle internal combustion piston or reciprocating engines are overcome by moving the combustion process out of the top of the cylinder below the intake valve into the passages within the cylinder head above the intake valve and between the compressor and using a positive displacement gear pump to compress the fuel mixture into these cylinder head passages and igniting the compressed charge within these passages as the piston reaches top dead center. This allows the combustion forces to open the intake valve releasing combustion products into the cylinder. Then only very high-pressure gases pass through the intake port into the cylinder eliminating torque fluxuations due to standing waves created in conventional engine head intake passages. In addition to achieving two-cycle operation in the present invention complete exhaust of exhaust gases is achieved because on the return stroke from bottom dead center to top dead center the piston forces all the exhaust gases out through exhaust ports located in the cylinder head.

### SUMMARY OF THE INVENTION

This invention comprises an internal combustion engine cylinder head designed to be used in conjunction with a cylinder block containing reciprocating means attached to a crankshaft located in the crankcase. One embodiment of this cylinder head has a housing horizontally divided into three sections along the center lines of the camshaft and the positive displacement gear pump and is bolted together for easy installation of the gear shafts and valve train.

The drive gears, which are powered by the crankshaft and drive the gear shafts and valve train, are located on opposite sides of the cylinder head. The gear train that drives the camshaft is contained within an extension of the housing to which a cover is bolted to seal the gears inside of the cylinder head. This cylinder head uses three overhead valves, two that are timed by the camshaft to open when the piston reaches bottom dead center to allow combustion products to be pushed out of the exhaust ports as the piston returns to top dead center. Dual exhaust passages are formed in the cylinder head leading to two exhaust ports through which exhaust gases flow out of the engine head. A centrally located overhead valve is operated by combustion forces and the camshaft that push it down upon the piston after the piston reaches top dead center opening the intake port allowing combustion products into the cylinder out of the combustion passages located within the cylinder head between the compressor and the valve. When this valve opens the burning gases flow into the cylinder and force the piston downward. The camshaft controls the closing of this valve.

Two identical gear shafts having four separate gears on each shaft are meshed together to form four positive displacement gear pumps within the cylinder head housing. The two end pumps function to pump oil to the bearing surfaces of the gear shafts and camshafts and to the drive gears attached to the gear shafts, housing and camshaft. Most internal passages providing lubrication to bearings are not shown.

Concentric air intake passages are formed outside of the housing compressor enclosures and serve to supply intake air to the compressor and cool the cylinder head of excess heat. These passages can be dedicated to cooling the cylinder head compressor enclosures with a coolant and additional intake passages provided in the cylinder head to supply air to the compressor if desired. The housing is designed to position the centerline between horizontal positive displacement gear shafts above and centered on the vertical axis of the cylinder in the engine block to which the cylinder head is attached.

The valve guides are positioned along a horizontal line centered between the parallel gear shafts and pass between the gear shafts so that the axis of the centrally located valve guide is axially aligned with the axis of the piston face. In this arrangement when the center valve pushes down upon the piston face as the valve opens after combustion initiates it pushes upon the center of the piston equally distributing the downward force the valve exerts upon the piston.

Spark plug holes are provided in the cylinder head so that spark ignition means may be installed into the head to ignite fuel compressed into the combustion passages formed within the housing between the compressor discharge and the center exhaust valve. These passages are centrally located along the centerline of the compressor discharge to provide the air discharged by the compressor a means to reach the center exhaust valve port and an open area within the head in which a spark plug electrode may be located.

Fuel injection means are shown installed in the intake passages upstream of the compressor or fuel may be directly injected into the internal combustion passages within the cylinder head located downstream of the compressor.

Attachment means such as boltholes to bolt the cylinder head to the engine block are not shown because the design of the cylinder block is unknown. Methods known in the art may be used to provide the present invention with the necessary fuel means, cooling means, ignition means, lubrication means, attachment means and air intake means necessary for correct engine operation.

In any embodiment of this invention conventional sensors and engine management systems can be included to produce optimal engine performance. Conventional fuel injection means and spark ignition means may be provided as well known in the art to provide the cylinder head with the necessary fuel and ignition required for engine operation. A water jacket can be designed into the cylinder head to provide the necessary cooling means if air-cooling proves to be insufficient or otherwise undesirable.

This discussion has outlined some of the more important objects of the invention. These objects should be construed as illustrative of the more important features and applications of the present invention. Many other important results can be obtained by applying the disclosed invention in different ways and modifying it within the scope of the disclosure. Accordingly, by referring to the detailed description of the disclosed embodiment taken together with the accompanying drawings and claims a more complete understanding of the invention may be ascertained.

### BRIEF DESCRIPTION OF THE DRAWINGS (SUBMITTED WITH PRELIMINARY DRAWINGS)

FIG. 1 is a front wire frame view of the housing of the engine head shown in FIG. 7.

FIG. 2 is a front wire frame view of the moving parts of engine head shown in FIG. 7.

FIG. 3 is a top wire frame view of the housing of the engine head shown in FIG. 7.

FIG. 4 is a top wire frame view of the moving parts of the engine head shown in FIG. 7.

FIG. 5. is a side wire frame view of the housing of the engine head shown in FIG. 7.

FIG. 6 is a side wire frame view of the moving parts of the engine head shown in FIG. 7.

FIG. 7 is a front view of an internal combustion engine cylinder head in accordance with one embodiment of the invention.

FIG. 8 is a top view of an internal combustion engine cylinder head in accordance with one embodiment of the invention.

FIG. 9 is a side view of an internal combustion engine cylinder head in accordance with one embodiment of the invention.

### DESCRIPTION OF THE PREFERRED EMBODIMENT

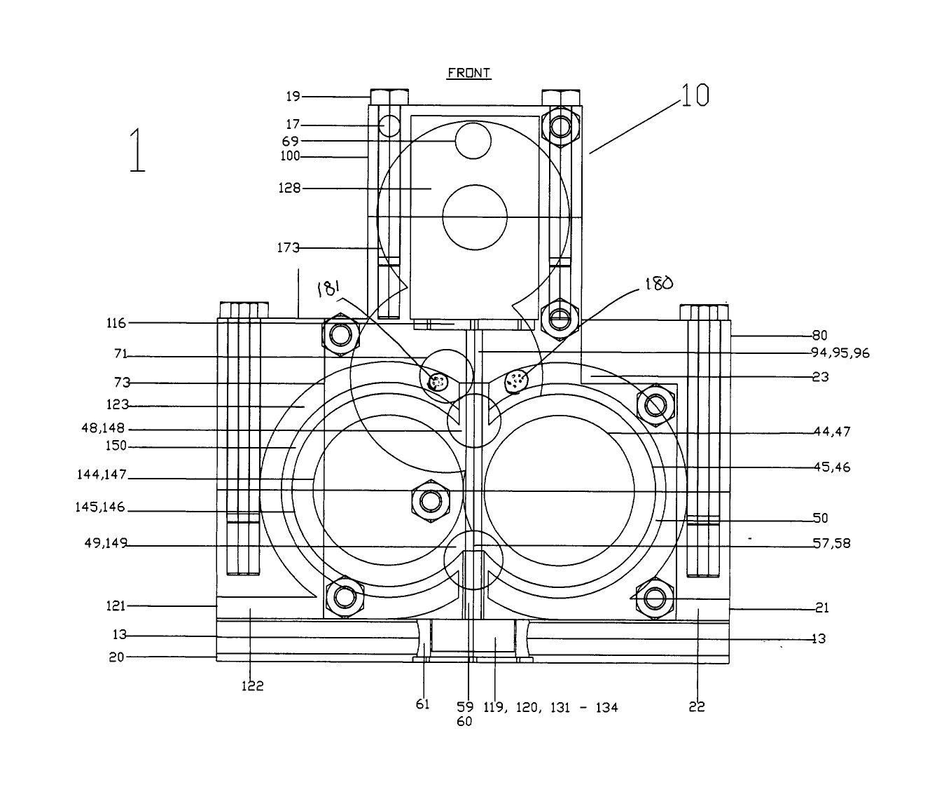

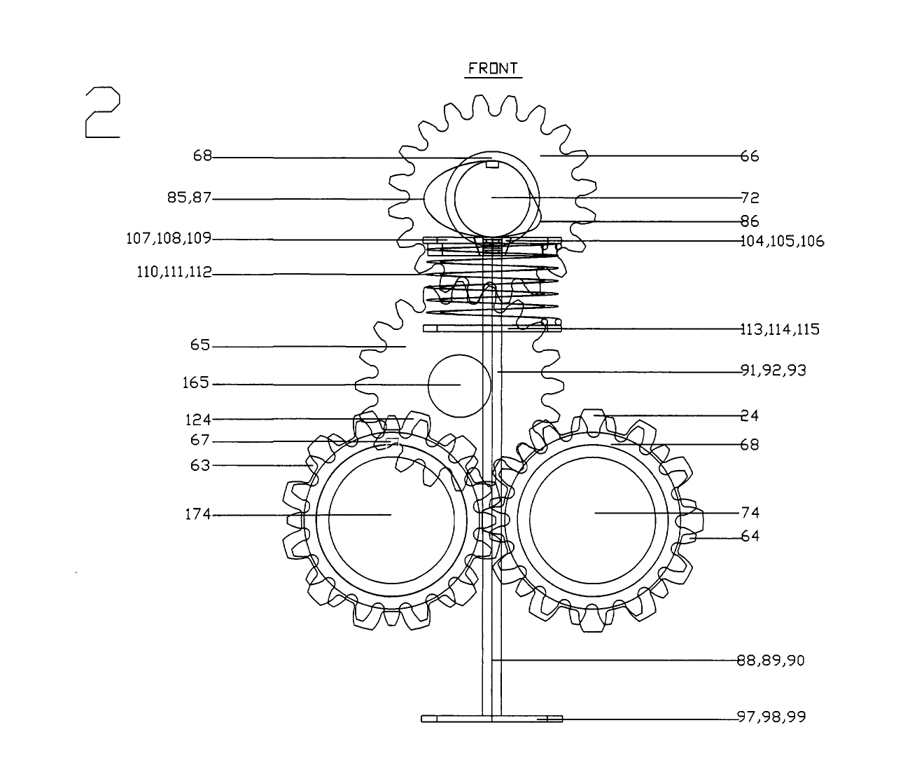

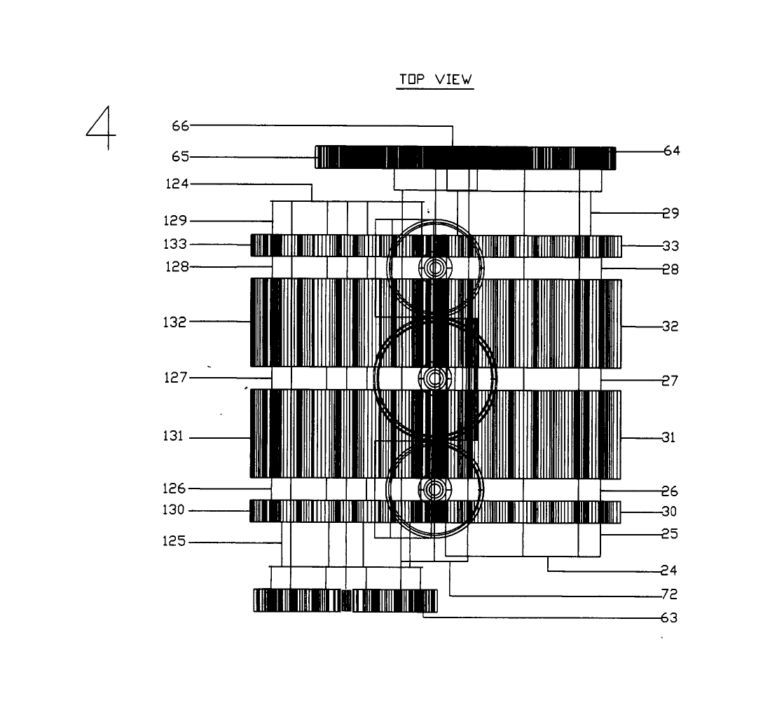

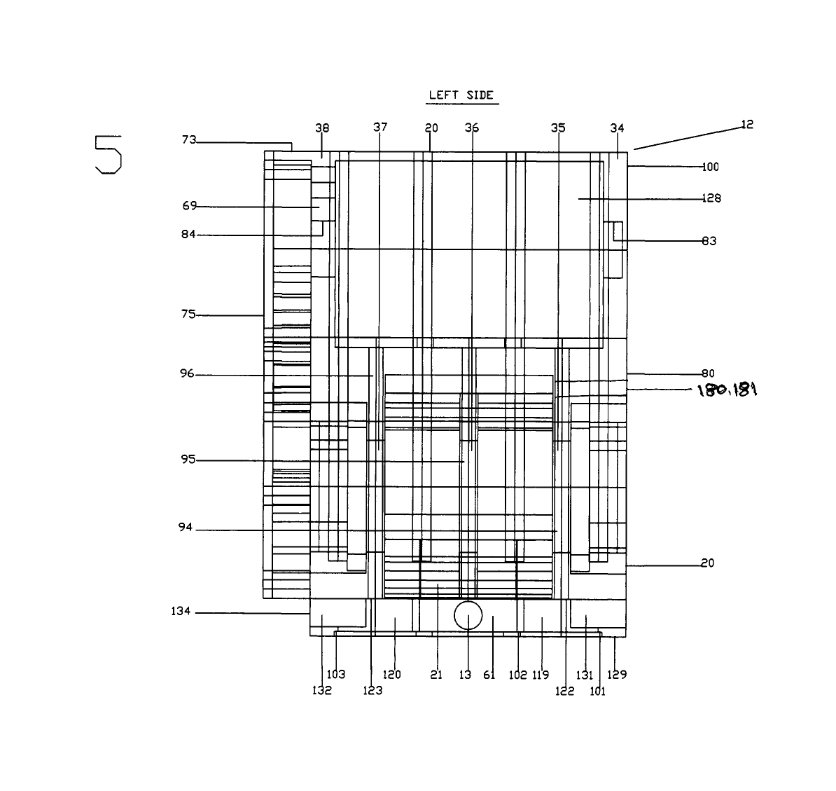

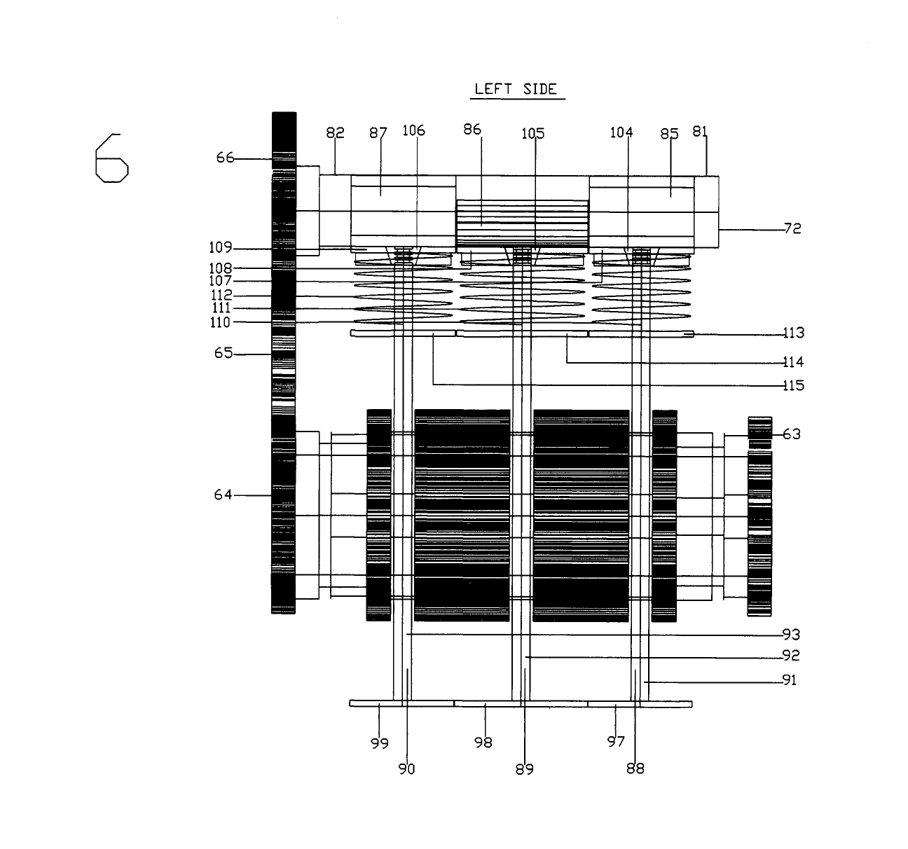

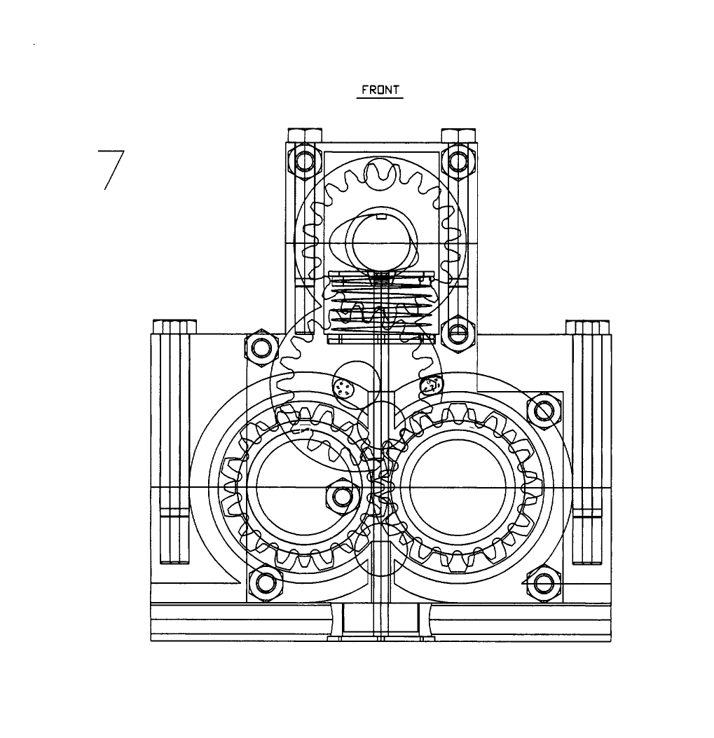

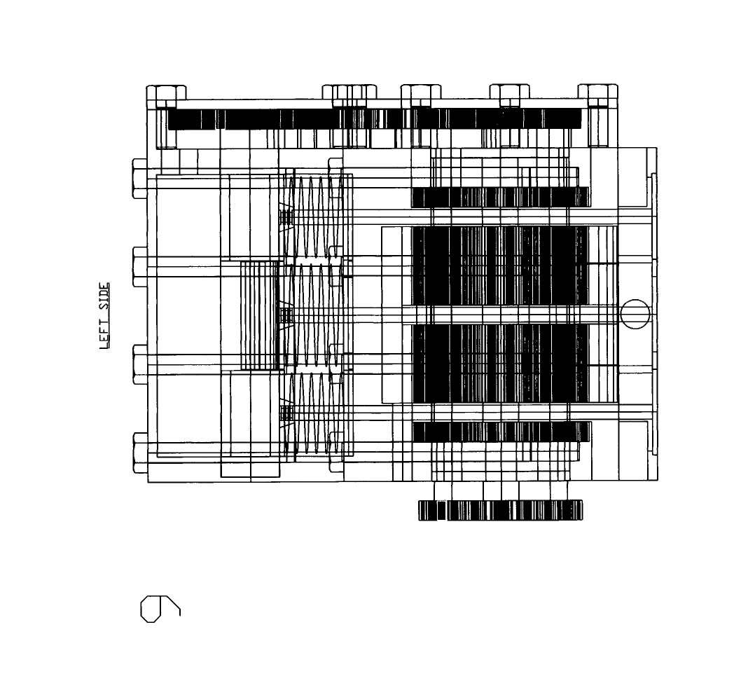

Referring to the drawings in detail, FIGS. 1-9 illustrate an internal combustion engine cylinder head and internal parts constructed in accordance with one embodiment generally referred to by reference numeral 10. The cylinder head is designed to be positioned above an internal combustion engine cylinder block containing a piston or other reciprocating means to cause two-stroke operation of the engine. In this embodiment the cylinder head is enclosed by a housing assembly 12, which is formed from three housing sections, 20, 80 and 100 horizontally divided. Bolts 19 pass through holes 17 located in the top exterior surfaces of 80 and 100 and thread into threaded holes in housing sections 20 and 80 to secure the housing sections together. Horizontal rectangular intake ports 21 and 121 are formed in the lower part of housing section 20 and centrally positioned above a circular spark plug hole 13 centrally located between the opposite sides of the lower head section 20 of said cylinder head 10 and projecting through said lower head section from the illustrated side to the opposite side. Intake port 21 connects to horizontal intake passage 22 and intake port 121 connects to horizontal intake passage 122 on the opposite side of the lower head section 20. Intake passage 22 connects to partially circular intake air passage 23 and intake passage 122 connects to partially circular intake passage 123. Intake air passage 23 is radially positioned around partial cylinder 50 and axially aligned with the axis of said partial cylinder. Intake air passage 123 is radially positioned around partial cylinder 150 and axially aligned with the axis of said partial cylinder. Gear shaft 24 is axially aligned with the axis of partial cylinder wall 50 and said wall of said partial cylinder 50 very closely spaced from the outer diameters of the gears of gear shaft 24. Gear shaft 124 is axially aligned with the axis of partial cylinder wall 150 and said wall of said partial cylinder 150 is very closely spaced from the outer diameter of the gears of gear shaft 124. Intake air passing through air passages 23 and 123 transfers heat received from the cylinder head walls surrounding air passages 23 and 123 thereby cooling the cylinder head.

Identical gear shafts 24 and 124 are divided by five bearing sections 25-29 on each shaft on gear shaft 24 and bearing sections 125-129 on gear shaft 124 into four gear sections on each shaft, two positive displacement oil pump gears 30 and 33 located near the ends of said gear shaft 24, two positive displacement oil pump gears 130 and 133 located near the ends of gear shaft 124 and two positive displacement fuel feed gears 31 and 32 located between said oil pump gears 30 and 33 on said gear shaft 24 and two positive displacement fuel feed gears 131 and 132 located between said oil pump gears 130 and 133 on said gear shaft 124. Positive displacement oil pumps 51 and 151 located near the ends of said gear shafts 24 and 124 and positive displacement fuel feed gear pumps 52 and 152 located between said oil pumps 51 and 151 on said gear shafts 24 and 124 are formed by meshing the eight gears located on identical gear shafts 24 and 124. Bearing holes 39 and 139, 40 and 140, 41 and 141, 42 and 142, 43 and 143 pass horizontally through vertical walls 34, 35, 36, 37 and 38 of upper head section 80 and lower head section 20 to provide bearing support for gear shaft 24 bearing surfaces 25, 26, 27, 28 and 29 and bearing surfaces 125, 126, 127, 128 and 129 of said gear shaft 124.

Horizontal partial cylinders 44 and 144 formed in upper head section 80 and lower head section 20 between vertical wall 34 and vertical wall 35 surrounds positive displacement oil pump 51 as clearly illustrated in. Horizontal oil inlet hole 48 passing through vertical wall 34 provides oil access to oil pump 51. Horizontal oil outlet hole 49 passing through vertical wall 34 provides oil access to gear train 61 comprised of gear shaft 124 output gear 63 fixedly attached to the end of said gear shaft by key 67. Gear shaft drive gear 63 is rotatably connected to the crankshaft of the engine by a chain, which is not shown, that drives said gear 63. Upon crankshaft rotation drive gear 63 rotates imparting rotation to attached gear shaft 124 that drives meshed gear shaft 24.

Horizontal partial cylinders 45 and 145 formed between vertical wall 35 and vertical wall 36 surrounds positive displacement fuel feed gear pump 52. Said cylinder 45 and 145 connect to a vertical air connection passage 55 formed between said partial cylinder 45 and partial cylinder 145 at their upper tangency and the upper sides of said passage 55 connect to the upper ends of said partial circular air intake passages 23 and 123. Intake air passes from said intake passages 23 and 123 through said passage 55 to positive displacement fuel feed gear pump 52 that pumps air received from vertical air connection passage 55 into horizontal combustion passage 57 located between internal vertical wall 40 and passage 59 from which the air flows into vertical combustion passage 59 passing downward and then into cylindrical combustion passage 61 located between the horizontal plane of the bottom of valve guide 95 and the top of the valve face 98. Combustion passage 61 surrounds and is axially aligned with the axis of valve stem 92 of valve 89 and has an outer diameter the same as the inner diameter of valve seat 102.

Horizontal partial cylinders 46 and 146 formed between vertical wall 36 and vertical wall 37 surrounds positive displacement fuel feed gear pump 152. Said cylinder 46 and 146 connect to a vertical air connection passage 56 formed between said partial cylinder 46 and partial cylinder 146 at their upper tangency and the upper sides of said passage 56 connect to the upper ends of said partial circular air intake passages 23 and 123. Intake air passes from said intake passages 23 and 123 through said passage 56 to positive displacement fuel feed gear pump 152 that pumps air received from vertical air connection passage 56 into horizontal combustion passage 58 located between internal vertical wall 42 and passage 60 from which the air flows into vertical combustion passage 60 passing downward and then into cylindrical combustion passage 61 located between the horizontal plane of the bottom of valve guide 95 and the top of the valve face 98. Combustion passage 61 surrounds and is axially aligned with the axis of valve stem 92 of valve 89 and has an outer diameter the same as the inner diameter of valve seat 102.

Horizontal partial cylinders 47 and 147 formed in upper head section 80 and lower head section 20 between vertical wall 37 and vertical wall 38 surrounds positive displacement oil pump 151. Horizontal oil inlet hole 148 passing through vertical wall 38 provides oil access to oil pump 151. Horizontal oil outlet hole 149 passing through vertical wall 38 provides oil to lubricate gear train 62 upon rotation of gear shaft 24 and drive gear 64 which drives idler gear 65 meshed with said drive gear 64. Idler gear 65 is meshed with camshaft drive gear 66 and imparts rotation to said gear 66 causing the camshaft 72 to rotate upon rotation of said gear shaft 24. The gear drive train 62 comprised of said gears 63, 65 and 66 is contained inside of gear train housing compartment 173. Gear train housing compartment 173 enclosing said gear train 62 is formed into housing extension 73 of upper and lower head section 20 and 80 and cam cover 100 and is covered by flat plate gear train housing extension cover 75 having bolt holes 77 through which bolts 17 tread into bolt holes 19 formed into said gear train housing extension 73. Oil hole 69 located in the side of said gear train housing compartment 173 passes through vertical wall 38 and provides oil to valve train compartment 128.

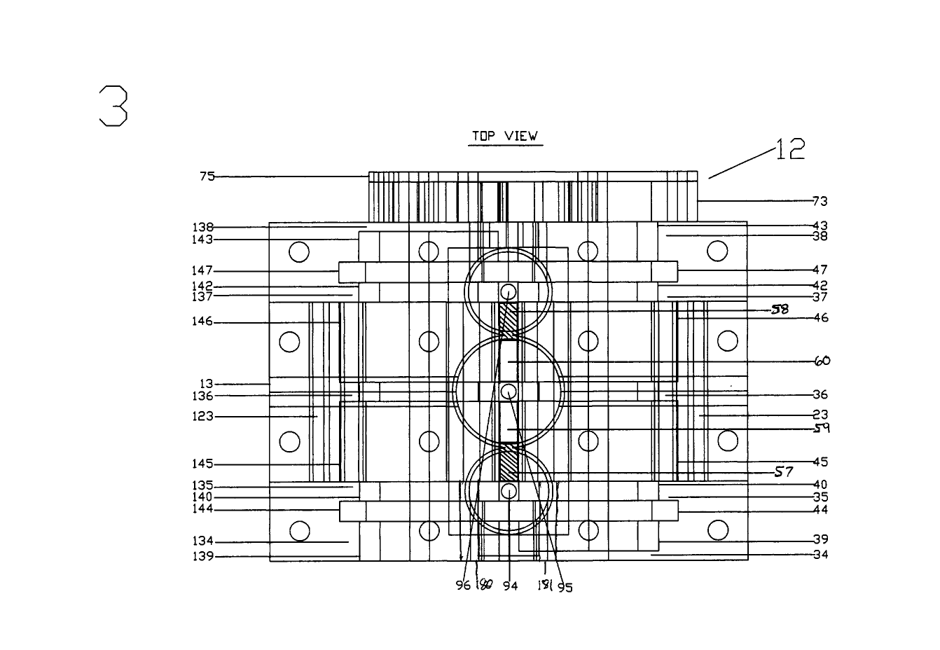

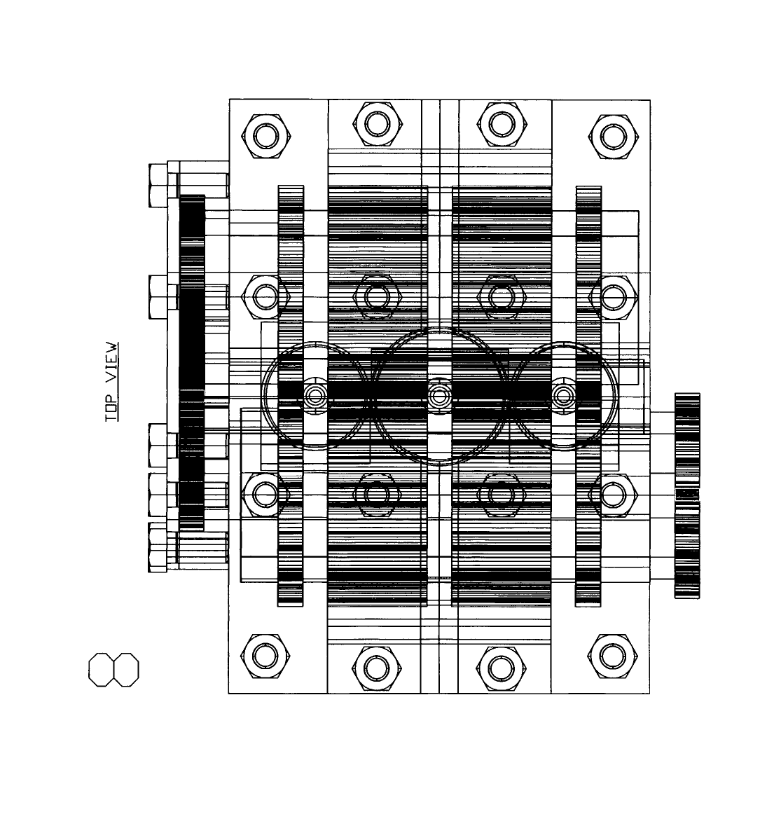

Camshaft 72 end bearing surface 81 is supported by blind bearing hole 83 formed in vertical wall 34 and end bearing surface 82 is supported by bearing hole 84 passing through vertical wall 38 of valve train cover 100 and upper head section 80 that join at the horizontal centerline of said camshaft forming the upper region of housing 10. Said camshaft has three cam exhaust lobes 85, 86 and 87 more clearly seen in FIG. 8, which actuate the exhaust valves 88, 89, and 90. Said exhaust valves are comprised of valves stems 91, 92 and 93 which extend through valve guides 94, 95 and 96 formed in upper and lower head section 20 and 80 and passing vertically through the center portions of internal vertical walls 35, 36, 37 formed in upper head section 80 and lower head section 20 that are located between gear shaft bearing surfaces 40 and 140, 41 and 141, 42 and 142 respectively allowing said valve stems to pass between the bearing surfaces 26 and 126, and 27 and 127, and 28 and 128 respectively of gear shafts 24 and 124 and extend to the valve faces 97, 98 and 99. Said valve faces upper outer surfaces are tangent with valve seats 101, 102 and 103 formed in the bottom horizontal wall 129 of lower head section 20. Said exhaust valves are connected at their upper ends to split valve keepers 104, 105 and 106 which have conically shaped outer surfaces which align with the inner conical holes centrally formed in the top walls of valve retainers 107, 108 and 109 which cover valve springs 110, 111 and 112 sitting on valve washers 113, 114 and 115 located on the bottom of valve spring seat holes 116, 117 and 118 formed in the upper interior horizontal wall 130 of upper head section 80. Said valve keepers, valve retainers, valve springs, valve washers, and valve seat holes are axially aligned with each valve stem axis and the said valve springs are kept under tension by compressing the said valve spring between the upper horizontal surface of said valve washers and the lower horizontal surface of said valve retainers which are held in position by the valve keepers that have internal circular grooves that are aligned with the external circular grooves formed near the ends of the valve stems as illustrated in FIG. 3, 6, and 8. Valve faces 97, 98 and 99 cover exhaust passages 119 and 120 and combustion passage 61. Said exhaust passages 119 and 120 are circular and project upward from said valve seats to internal exhaust passage horizontal walls 122 and 123 which form the upper walls of internal horizontal rectangular exhaust passages 131 and 132 respectively that extend through lower head section 20 to exhaust ports 133 and 134 respectively formed in the opposing external vertical walls of lower head section 20.

Upon starting the engine by rotating the crankshaft the gear trains 61 and 62 cause rotation of said camshaft 72, which rotates said cam lobes 85, 86 and 87 against the valve stems 91, 92 and 93. The cam lobes are radially positioned around the axis of the camshaft and the center cam lobe 86 is oriented to cause the middle valve to begin to open upon ignition of the fuel and air mixture in the combustion passages 57-61 which is timed to occur when the piston reaches the top dead center position. Said combustion passages are filled with compressed air as the crankshaft rotates prior to ignition because rotation of the crankshaft causes rotation of gear shafts 24 and 124. Rotation of said gear shafts causes operation of the four gear pumps formed by the meshed gears on gear shafts 24 and 124. Operation of the two positive displacement gear pumps 52 and 152 force air into the combustion passages 57-61 within the cylinder head 10 where compression of the air occurs. Maximum compression of the air trapped inside of the said combustion passages is attained as the piston reached top dead center. Fuel injection means 180 and 181 are shown placed within passages 23 and 123 upstream said positive displacement gear pumps 52 and 152 to inject fuel into the said intake passages or may be placed to inject fuel directly into the said combustion passages but this arrangement is not shown so that fuel can be injected into the cylinder head at the desired degrees of crankshaft rotation to supply fuel to the engine. Spark ignition means such as spark plugs, which are not shown, can be positioned in spark plug holes 22 and 122 that connect into combustion passage 61 to ignite the fuel mixture at the desired moment.

Upon ignition of the fuel mixture combustion of the fuel charge compressed into combustion passages 57-61 occurs and the burning gases produce high pressure within said combustion passages forcing the combustion passage intake valve 89 downward against the piston face. The piston face is tangent or nearly tangent with the lower side of said combustion passage exhaust valve face when the piston is positioned at top dead center within the cylinder bore. As the intake valve 89 moves downward against the piston face under the force of the camshaft and the expanding combustion gases the valve face moves off the exhaust valve seat 102 opening the port in the bottom of combustion passage 61 allowing the burning expanding combustion gases to flow into the cylinder equalizing the pressures within the cylinder and the combustion passages. The high-pressure gases of combustion fill the cylinder and act upon the downward moving piston increasing the force exerted upon it increasing the torque generated at the crankshaft. As the crankshaft continues to drive the gear shafts more air is feed into the said combustion passages increasing the amount of oxygen supplied to the combustion process, which causes an increase in the rate of combustion within the said combustion passages and cylinder increasing the pressure within the said combustion passages and cylinder and increasing the force exerted upon the piston face thereby increasing the torque generated by the crankshaft. Due the continuous addition of air into the combustion process while the intake valve is open faster burning of the fuel charge occurs and allows more fuel to be burned in the engine. When the fuel supply to the combustion passages is stopped the additional air constantly being supplied to the combustion process causes faster oxidation of the remaining unburned fuel. The camshaft exhaust lobe 86 is designed to control the return travel of intake valve 89 said intake valve returns to the valve seat closing the combustion passage from the cylinder at which time the combustion passages refill with fresh air as the piston continues to move within the cylinder bore. Due to the very limited volume of the cylinder head combustion passages 57-61 the continuous supply of fresh air to said combustion passages from the positive displacement gear pumps 52 and 152 quickly extinguishes the burning fuel within said combustion passages after the fuel injection means has been turned off and the intake valve has closed.

When the piston has reached bottom dead center position the cam lobes 85 and 87 begin to actuate exhaust valves 88 and 90 thereby opening the exhaust passages 119 and 120 allowing the burned fuel trapped within the cylinder to be escape through said exhaust passages into horizontal rectangular exhaust passages 131 and 132 through which the engine exhaust passes and afterwards escapes from the lower head section 20 by passing through exhaust ports 133 and 134 located at the ends of said exhaust passages 131 and 132 as the piston returns to the top dead center position. The cam lobes 85 and 87 are oriented to close the said exhaust valves 88 and 90 by the time the piston has reached the top dead center position to prevent gas from escaping from the cylinder through these exhaust passages during the power stroke of the piston which occurs again as the piston passes the top dead center position.

1. An internal combustion engine head for use with piston engines comprised of a housing containing a compressor means for forcing air into the engine, valve means to open and close ports located in the engine head, passage means leading from the exterior wall of the head to the compressor to pass air to the compressor, drive means to drive the compressor and the valve means from the crankshaft, fuel injection means, cooling means to cool the engine head, lubrication means to provide lubrication to bearing surfaces of the moving parts within the head, the improvement comprised of combustion passages and ignition means located within the engine head between the compressor means outlet and the valve port located next to and directly above the top of the cylinder and initiating combustion within the said combustion passages.

2. The engine head, as defined in claim 1, wherein the said valve means is comprised of a camshaft parallel with the compressor means and positioned above the compressor means.

3. The engine head, as defined in claim 2, wherein the said valve means includes a valve port located in the bottom wall of the engine head and axially aligned with the axis of the cylinder beneath it. Said valve port is connected to said combustion passages so combustion gases can pass through said valve port into the cylinder of the engine when the valve covering the said valve port opens.

4. The engine head, as defined in claim 3, wherein said valve covering said port, upon ignition of fuel compressed within said combustion passages, pushes down upon the face of the piston when the piston is at top dead center opening said valve port to allow combustion gases to enter the cylinder.

5. The engine head, as defined in claim 3, wherein said cooling means includes two partial cylinder air intake passages one axially aligned with one gear shaft axis the other axially aligned with the other gear shaft axis of a positive displacement gear type air compressor. Said air intake passages surround the gear shaft housing so the intake air passing through said air intake passages cool the gear housing during operation of the engine.

6. An internal combustion engine head for use with piston engines comprised of a housing containing a compressor means for forcing air into the engine, valve means to open and close ports located in the engine head, passage means leading from the exterior wall of the head to the compressor to admit air into the compressor, drive means to drive the compressor and the valve means from the crankshaft, cooling means to cool the engine head, lubrication means to provide lubrication to bearing surfaces of the moving parts within the head, combustion passage means leading from the compressor means outlet to the valve port, ignition means to ignite the mixture contained in said passage means located between the compressor means and the valve port, the improvement comprised of means to continuously pump air during engine operation into said combustion passage means located between the compressor outlet and the valve port during all 360 degrees of crankshaft revolution.

7. The improvement as defined in claim 1 wherein said compressor means is comprised of a positive displacement gear type air compressor located in the engine head.

8. The improvement as defined in claim 1, including means to continuously pump air during engine operation into said engine head combustion passage means located between the compressor outlet and the engine head valve port during the combustion process occurring in said passage means.

9. The improvement as defined in claim 6 wherein said passage means leading from the outside wall of the engine head to the compressor means to pass air into the engine head includes two partial cylinder passages one axially aligned with one gear shaft axis the other axially aligned with the other gear shaft axis of a positive displacement gear type air compressor. Said air intake passages surround the gear shaft housing so the intake air passing through said air intake passages cool the gear housing during operation of the engine.

10. The improvement as defined in claim 1 wherein said valve means includes camshaft operated exhaust valve means to release exhaust gases trapped in the cylinder out through the engine head.

11. The improvement as defined in claim 6 wherein said valve means includes exhaust valve means to release exhaust gases out of the engine cylinder through the engine head.

12. The improvement as defined in claim 10 including valve means to release combustion products trapped in said engine head combustion passages into the engine cylinder.
